(19) United States
(12) Patent Application Publication
(10) Pub. No.: US 2014/0208419 A1
(43) Pub. Date: Jul. 24, 2014

(54) User Authentication

(71) Applicant: International Business Machines Corporation, Armonk, NY (US)

(72) Inventors: Matthew-Louis Chen Wen Chang, Oxford (GB); John W. Duffell, Winchester (GB); Sophie D. Green, Hursley (GB); Sam Marland, Gwynedd (GB); Joe Pavitt, Essex (GB); Stephen D. Pipes, Winchester (GB)

(73) Assignee: INTERNATIONAL BUSINESS MACHINES CORPORATION, Armonk, NY (US)

(21) Appl. No.: 14/161,818

(22) Filed: Jan. 23, 2014

(30) Foreign Application Priority Data
Jan. 24, 2013 (GB) 1301218.2

(51) Int. Cl. G06F 21/31

(52) U.S. Cl. CPC G06F 21/31
USPC 726/21

(57) ABSTRACT

Disclosed is a method for providing a user access to a computer system comprising a plurality of services and a plurality of authentication levels, the method comprising dynamically monitoring a risk profile of a user authenticated on said computer system; dynamically selecting an authentication level for each of said services based on said monitored risk profile; and if said authentication level for a service is higher than an actual authentication level for said user, sending a further authentication request to the user requesting the user to provide authentication information corresponding to the dynamically selected authentication level upon said authenticated user requesting access to said service.

### FIELD OF DISCLOSURE

The claimed subject matter relates to techniques for providing a user access to a computer system comprising a plurality of services and a plurality of authentication levels. The claimed subject matter further relates to a computer program product comprising computer-readable program code for implementing such a method when executed on a computer. The claimed subject matter yet further relates to a computer system implementing such a method.

### BACKGROUND

Networked computer systems offering a multitude of services to authorized users are commonplace. Indeed, society is shifting towards an electronic way of life, in which many daily tasks are performed over such networks. An unwanted consequence of this shift in paradigm is that criminal activity is also evolving in the electronic realm. Cybercrime including identity theft is a serious problem, which results in several billions of dollar losses per annum, e.g. because a criminal has assumed the identity of someone else on such a network. This is particularly relevant to financial services, e.g. on-line banking, as well as to on-line shopping services such as Amazon, where user credit card details are stored under a user profile. Other relevant examples will be apparent to the skilled person.

To counteract such malicious behavior, a user of such a computer system typically has to go through an authentication process to gain access to the computer system, e.g., by providing a username and password. Although this reduces the risk of identity fraud, i.e. an imposter gaining access to the account of the user, such authentication may not be sufficient to prevent such identity fraud altogether. For instance, there is an increasing trend to perform electronic transactions on mobile devices such as smart phones and tablets. If such a device gets stolen whilst its owner is using a service that required authentication, the thief has immediate access to this service without it being protected by the authentication process. Even if the user is not yet authenticated, the mobile device may store at least some of the authentication data in auto complete functions, which may aid the criminal in accessing the service of interest. The same problem can occur if a user is forced by a criminal to access the service of interest or when the user accessed the service through a public access device such as a computer in an Internet café, and did not properly terminate his session before leaving the computer.

Part of this problem can be addressed by the use of several layers of authentication for critical services, but this can cause friction with the end user as the end user typically has to memorize several complex passwords, which often leads to forgotten authentication details, causing frustration for the end user and increasing cost for the service provider in terms of the provision of call centers and help desks that can assist the end user in regaining access to the requested services.

It is known to request additional authentication from a user if the user tries to access a service over an Internet connection from a ‘new’ IP address. This is for instance disclosed in U.S. Pat. No. 7,908,644 B2. However, this approach does not solve the aforementioned problems as once a device is trusted there is no additional protection for the user against identity theft using a trusted device.

US 2011/0314558 A1 discloses a method for authenticating access to an electronic document including receiving an authentication request from a user, receiving an aggregate risk score, selecting an authentication mechanism based at least on the aggregate risk score, and applying the authentication mechanism to decide the authentication request from the user. This process may be periodically repeated to prevent access to the electronic document by anyone else than the intended user. This for instance prevents unauthorized access of the electronic document by a third party on a device on which the intended user gained access to the requested document but forgot to properly terminate the initiated session. Although this significantly reduces the risk of malicious access to a service such an electronic document, the problem remains that once the user has been authenticated, the user gains full access to all services which the authenticated user is authorized.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF SUMMARY OF THE INVENTION

The claimed subject matter seeks to provide a more robust method for providing a user access to a computer system comprising a plurality of services and a plurality of authentication levels.

The claimed subject matter further seeks to provide a computer program product comprising computer-readable program code for implementing the steps of such a method when executed on a computer.

The claimed subject matter yet further seeks to provide a computer system implementing such a method.

According to an aspect of the claimed subject matter, there is provided a method for providing a user access to a computer system comprising a plurality of services and a plurality of authentication levels, the method comprising dynamically monitoring a risk profile of a user authenticated on said computer system; dynamically selecting an authentication level for the requested service based on said monitored risk profile; and if said authentication level is higher than an actual authentication level for said user, sending a further authentication request to the user requesting the user to provide authentication information corresponding to at least the dynamically selected authentication level upon said authenticated user requesting access to said service.

In the claimed subject matter, access to available services on a (networked) computer system is gained using dynamically assigned authentication levels based on a monitored risk profile of the user. Optionally, the authentication levels are assigned based on a combination of the monitored risk profile and the intrinsic authorization level of the requested service.

Consequently, if during a user session there is a change in the monitored risk profile, the required level of authentication for the services is changed accordingly. Hence, rather than a user obtaining full access to all services within his authorization profile upon successfully passing an (additional) authentication protocol, the authorization profile of the user is dynamically adapted upon changes in his monitored risk profile by changing the required level of authentication for a service in response to the change in the risk profile. This has the advantage that the authentication method becomes more robust to identity fraud.

In an embodiment, the step of sending a further authentication request to the user further comprises providing the user with an authentication selection menu comprising a plurality of authentication options, each of said options at least matching the dynamically selected authentication level. This has the advantage that the user may select his or her preferred authentication method without compromising security as only authentication methods are being offered to the user that match or exceed the appropriate authentication level.

The method typically further comprises the steps of receiving the further authentication information from said user; verifying the further authentication information; and providing the user access to the requested service upon positive verification of the further authentication information in order to provide genuine users access to the requested service.

In an embodiment, the method further comprises adjusting the risk profile of the user upon receiving incorrect further authentication information from said user. This further protects the system from identity fraud as failed authentication attempts will reduce the level of trust in the user and may cause an increase in the required authentication level, thus making it more difficult for a fraudulent user to gain access to a requested service.

In an embodiment, the method further comprises receiving a request on said computer system from a user to access a service on said computer system; determining an initial risk profile of said user; selecting an initial authentication level based on said initial risk profile; and sending an initial authentication request to the user requesting the user to provide authentication information corresponding to the dynamically selected initial authentication level. In this embodiment the initial authentication level is also dynamically set based on the risk profile of the user, which further improves the robustness of the method against identity fraud. This step may however be omitted if the confidence in the user's identity is sufficiently high, in which case the request for authentication information may be omitted altogether.

This embodiment may further comprise the steps of receiving the initial authentication information from said user, verifying the initial authentication information; and providing the user access to the service upon positive verification of the initial authentication information to provide genuine users access to the computer system.

The step of dynamically monitoring a risk profile of a user may advantageously comprise collecting user-relevant data selected from at least one of biometric data, location data, environmental data and user device monitoring data.

The user risk profile may comprise a plurality of risk levels, in which case the method may further comprise generating a notification signal upon a transition of the monitored risk profile from a first risk level to a second risk level. This avoids having to continually change the minimally required authentication levels for the services each time a small change in the risk profile of the user is detected.

The method may further comprise the step of generating an identity token for the user following successful authentication to identify the user on the computer system.

In accordance with another aspect of the claimed subject matter, there is provided a computer program product comprising a computer-readable storage medium having computer-readable program code, when executed on at least one processor of a computer, causing the computer to implement the steps of the method according to one or more embodiments of the claimed subject matter.

According to yet another aspect of the claimed subject matter there is provided a computer system comprising a risk profile monitor adapted to dynamically monitor a risk profile of a user authenticated on said computer system; and an authentication module adapted to dynamically select an authentication level for a service based on said monitored risk profile; compare the dynamically selected authentication level of a service requested by said user with the actual authentication level of said user; and send a further authentication request to the user requesting the user to provide authentication information corresponding to the dynamically selected authentication level if said dynamically selected authentication level is higher than the actual authentication level for said user. This computer system thus provides a more robust protection against identity fraud for at least the reasons as explained above.

The system may further comprise an environmental monitor adapted to monitor user-relevant data selected from at least one of biometric data, location data, environmental data and user device monitoring data, wherein said risk monitor is adapted to dynamically monitor said risk profile using said user-relevant data.

The authentication module may be further adapted to select an initial authentication level for said user in response to receiving a request on said computer system from said user to access said computer system, said initial authentication level being selected based on an initial risk profile of said user; and the risk profile monitor may be further adapted to determine said initial risk profile to extend the increased robustness of the computer system against e.g. identity fraud to the initial authentication process.

Preferably, the risk profile comprises a plurality of risk levels, and wherein the risk profile monitor is adapted to signal the authentication module upon a transition of a monitored risk profile from a first risk level to a second risk level to reduce the frequency of changes to the required authentication level for the services offered by the computer system.

In an embodiment, the computer system comprises at least one processor, and wherein at least one of the authentication module and the risk profile monitor are implemented on the at least one processor.

The computer system may further comprising a user interface for requesting access to the computer system such as an automated teller machine (ATM).

### BRIEF DESCRIPTION OF THE DRAWINGS

Preferred embodiments of the claimed subject matter will now be described, by way of example only, with reference to the following drawings, in which:

FIG. 1 schematically depicts an aspect of a method according to an embodiment of the claimed subject matter;

FIGS. 2 and 3 together depict a flow chart an embodiment of a method according the claimed subject matter;

FIG. 4 depicts a flow chart of an aspect of an alternative embodiment of a method according to the claimed subject matter; and

FIG. 5 schematically depicts a computer system according to an embodiment of the claimed subject matter.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

In the context of the present application, where embodiments of the claimed subject matter constitute a method, it should be understood that such a method is a process for execution by a computer, i.e. is a computer-implementable method. The various steps of the method therefore reflect various parts of a computer program, e.g. various parts of one or more algorithms.

The various embodiments of the method of the claimed subject matter may be stored as computer-executable program code on a computer program product comprising a computer-readable storage medium. The computer-readable storage medium may be any medium that can be accessed by a computer for the retrieval of digital data from said medium. Non-limiting examples of a computer-readable storage medium include a CD, DVD, flash memory card, a USB memory stick, a random access memory, a read-only memory, a computer hard disk, a storage area network, a network server, an Internet server and so on.

In the context of the present application, a (computer) system may be a single device or a collection of distributed devices that are adapted to execute one or more embodiments of the methods of the claimed subject matter. For instance, a system may be a personal computer (PC), a server or a collection of PCs and/or servers connected via a network such as a local area network, the Internet and so on to cooperatively execute at least one embodiment of the methods of the claimed subject matter.

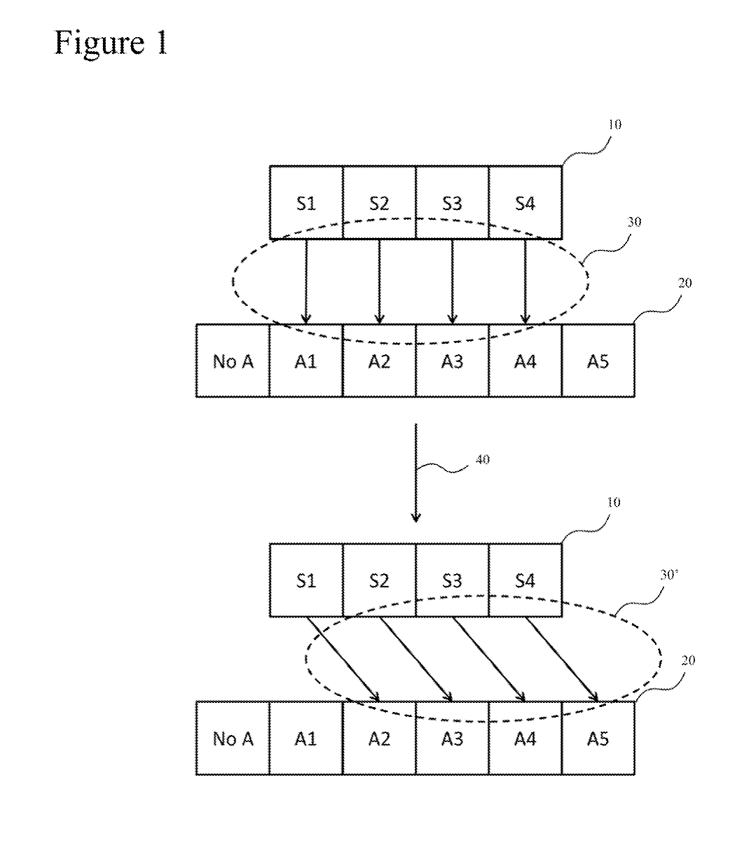

FIG. 1 schematically depicts the concept of the claimed subject matter. A computer system offers a group 10 of services S1-S4, such as a system facilitating financial transactions of some kind. As a non-limiting example, S1-S4 may be services as depicted in Table 1, although hit should be understood that many other types of services are of course equally feasible. Such services are typically associated with different authorization levels, i.e. for more critical services a higher level of authorization is required.

TABLE 1

| Service | Description |
|---|---|
| S1 | locate ATM in ATM network of the computer system |
| S2 | Balance enquiry |
| S3 | Pay existing payee |
| S4 | Pay new payee |

Although in Table 1, S1-S4 are shown as single services, it is equally feasible that S1-S4 are classes of services with multiple services per class. In FIG. 1, each of the (classes of) services S1-S4 is assigned an authentication method from the tiered authentication structure 20. For instance, each service S1-S4 is assigned an authorization level, which is dynamically mapped onto zero or more authentication methods. This structure 20 by way of non-limiting example comprises the authentication methods as shown in Table 2.

TABLE 2

| Method | Description |
|---|---|
| NoA | No authentication required |
| A1 | Prompt user for username and password |
| A2 | As A1, plus additional challenge question |
| A3 | As A2, plus additional key required |
| A4 | As A2, plus biometric verification required |
| A5 | As A3, plus biometric verification required |

Again, it is emphasized that the definition of the various authentication methods is by way of non-limiting example only, and that any suitable number and type of authentication methods may be included in the tiered authentication structure 20.

Each service or service class S1-S4 in the service group 10 is assigned an authentication method from the tiered authentication structure 20 by means of a mapping function 30, which mapping function itself is a function of a risk profile of the user of the computer system. In other words, the mapping function 30 is chosen based on the level of confidence or trust in the identity of the user. This risk profile may be calculated from the monitoring of so-called environmental parameters for a user already authenticated on the computer system, as will be explained in more detail later. Upon a change 40 in the risk profile of the authenticated user caused by a change in these environmental parameters, the computer system will alter the mapping function 30 to a mapping function 30′, which results in a different level of authentication becoming required for the user to access one of the services S1-S4 (or a service in service classes S1-S4).

So for instance, upon an increase in the risk profile for the user, i.e., a reduction in the trust level for this user, a required authentication level for a service may be increased, as shown in FIG. 1. Table 3 gives a non-limiting example of mapping functions 30, 30′ for different risk profiles.

TABLE 3

| | Low Risk | Medium Risk | High Risk |
|---|---|---|---|
| S1 | NoA | A1 | A3 |
| S2 | A1 | A2 | A4 |
| S3 | A2 | A3 | A5 |
| S4 | A3 | A4 | N/A |

In Table 3, three mapping functions for a low risk profile, medium risk profile and high risk profile are shown by way of non-limiting example. It should be understood that any suitable number of mapping functions for any suitable granularity of risk profiles may be applied. In the non-limiting example of Table 3, a user having a low risk profile, i.e. for which there is a high level of trust in his identity, may access service S1 or services in service class S1 without requiring (additional) authentication. In contrast, a user having a high risk profile, i.e. for which there is a low level of trust in his identity, may only access service S1 or services in service class S1 upon successfully completing authentication method S3 or greater, and may not be allowed access to service level A4 at all. It will be understood that the selection or definition of the mapping function for applicable risk profiles is a design choice, such that any suitable mapping function may be defined without departing from the teachings of the claimed subject matter.

It is reiterated that although the above principles may also be applied upon a user trying to gain access to the computer system, these principles are applied particularly advantageously once the user has successfully gained access to the computer system by passing an initial authentication method, such that the trust level or risk profile for the user assessed during the initial log-in is dynamically monitored during the user session, thus at least to some extent negating the detrimental consequences of an initially trusted user changing identity during the user session. Consequently, if the initial level of authentication provided by a user becomes insufficient for accessing a particular service, the computer system may request that the user provides at least the appropriate level of authentication for the requested service based on the mapping function corresponding to the actual risk profile of the user.

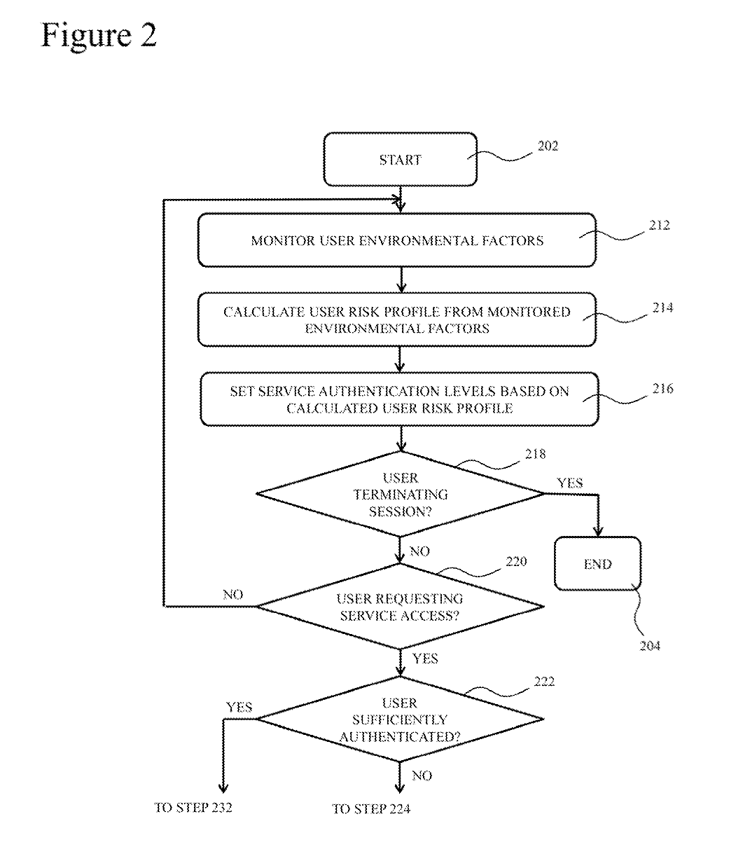

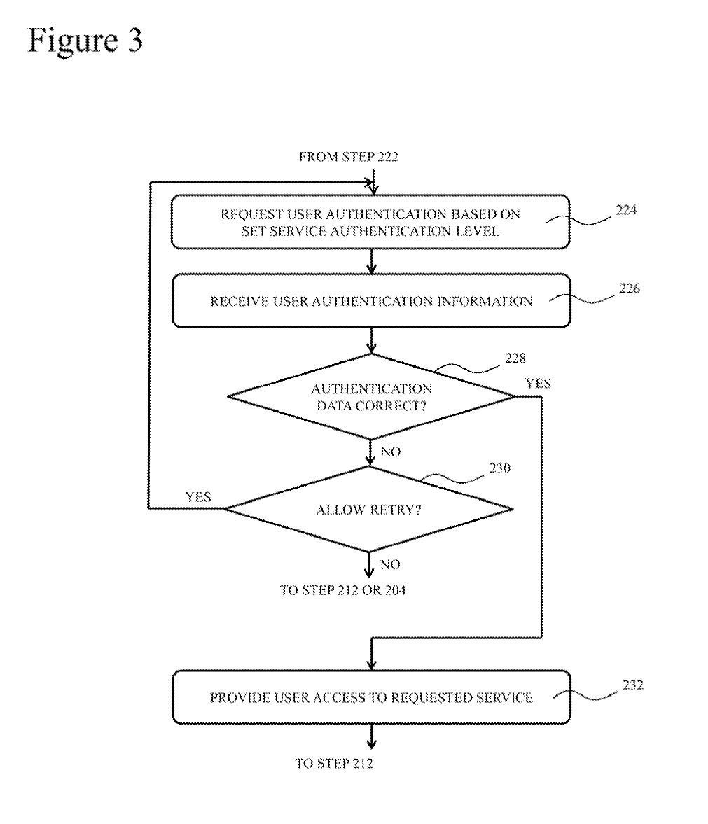

FIG. 2 and FIG. 3 combined show an embodiment of the dynamic authentication method of the claimed subject matter. It should be understood that the order of method steps in this method are dependent of the chosen implementation of the method, such the displayed order of steps is by way of non-limiting example only, and that any suitable order of these steps may be used without departing from the teachings of the claimed subject matter.

The method starts in a step 202 by authenticating a user and granting the user access to the computer system following a successful completion of the initial authentication method. It is noted for the sake of clarity that the initial authentication may be to simply grant a user access to the computer system (or to a requested service) if this is permitted in the policy for the appropriate risk profile, e.g. requesting a user to provide identity details only. This access may be granted in any suitable manner, e.g. by generating an identity token on the system for the user following this successful completion. The method subsequently proceeds to a step 212, where the environmental factors or parameters of the user are being monitored for the purpose of calculating the user risk profile from these monitored environmental factors in a step 214. Any suitable environmental factor that can be used for calculating such a risk profile may be monitored. Non-limiting examples of suitable environmental factors include location information from the user device, e.g. GPS location information, IP address information of the user device, the type of user device (e.g. a user requesting access to a service on a mobile phone may be considered having a high risk profile, whereas a user requesting access to the same service at an ATM may be considered having a low risk profile), user behavior on the user device, e.g. a predefined set of key strokes, biometric data for the user, context information obtained from a camera of the user device, and so on. The collection of such environmental factors is known per se, such that it suffices to state that this data may be collected in step 212 in any suitable manner.

Next, control proceeds to step 214 in which the collected environmental factors are used to calculate a risk profile for the user. Any suitable algorithm may be used for this purpose. For instance, the user may be assigned a risk score from 0-100 with 0 indicating the lowest risk and 100 indicating the highest risk based on the collected environmental factors, e.g. by assigning risk scores to individual environmental factors and combining these individual risk scores to obtain the risk profile for the user, or in any other suitable manner. It is noted that the calculation of a risk profile for a user is known per se, as for instance is evident from US 2011/0314558 A1, such that it suffices to state that any suitable calculation method for obtaining the risk profile from the monitored environmental factors may be used.

Upon calculation of the user risk factor in step 214, control proceeds to a step 216 in which the authentication levels 20 for services (or service classes) S1-S4 are set in accordance with the calculated risk profile for the user of the computer system. This process is repeated to ensure that the risk profile of the user and the associated mapping of the authentication methods onto the available services remains up-to-date until the user terminates the user session as checked in a step 218, in which case the process terminates in step 204, or until the user requests access to one of the services S1-84 (or alternatively a service in one of the service classes S1-S4) as checked in a step 220, in which case the method proceeds to a step 222, which defines a policy enforcement point in the method of the claimed subject matter.

Specifically, upon the user requesting access to one of the services of the computer system, it is checked in step 222 if the initial level of authentication of the user that allowed the user to gain access to the computer system in step 202 is sufficient to allow the user access to the requested service without requiring the user to provide additional authentication. To this end, the actual authentication level set for this service in step 216 in accordance with the actual risk profile of the user as calculated in step 214 is compared with the level of authentication initially provided by the user in step 202. Where the initial level of authentication is sufficient, the method proceeds directly to step 232 where the user is granted access to the requested service. If the initial level of authentication proves insufficient to allow the user direct access to the requested service, either because the initial level of authentication was insufficient or because the risk profile of the user has changed during the session, the method proceeds to step 224, in which the computer system prompts the user to provide the additional authentication information as required by the authentication level set in step 216 for the requested service.

The user may be requested to provide one or more types of information as required by the authentication level and the user may volunteer additional information, e.g. information appropriate for a higher authentication level in order to gain access to the requested service. For instance, the user may be provided with an authentication selection menu comprising a plurality of authentication options, each of said options at least matching the dynamically selected authentication level. This has the advantage that the user may select his or her preferred authentication method without compromising security as only authentication methods are being offered to the user that match or exceed the appropriate authentication level.

In an embodiment, it may be decided in step 222 that a user should always be prompted to provide the authentication information required to access the requested service even when the initial level of authentication as provided in step 202 was sufficient if the risk profile of the user has increased beyond the initial risk profile of the user during the session.

In step 226, the authentication information is received from the user, for which it is checked in step 228 if the received authentication information is correct. If this is the case, the method proceeds to step 232 in which the user is granted access to the requested service, after which the method returns to step 212 for the continued monitoring of the user risk profile. If the received authentication information is incorrect, the user may be given a number of additional opportunities to provide the correct authentication information, as symbolically depicted by step 230, in which case the method returns to step 224. If no further retries are allowed, the method may return to step 212 without providing the user access to the requested service or alternatively the session of the user may be terminated in step 204.

In an embodiment, the provision of incorrect (or correct) authentication information may negatively (or positively) affect the risk profile of the user. In this embodiment, the check of authentication information in step 228 implicitly includes step 212, and the provision of such details will trigger the method to revert back to step 214 for a recalculation of the risk profile of the user, which may in fact lead to a user being confronted with a higher level of authentication being required to gain access to the requested service in case of the provision of incorrect authentication details or to a reduction in the required level of authentication for subsequent service request upon the user providing correct authentication information.

In a variant to the embodiment shown in FIG. 2, it is equally feasible to include a risk assessment in the initial authentication step in 202. In this embodiment, which is not explicitly shown in the present application, the initial authentication in step 202 may be preceded by the calculation of the risk profile for the user in step 214 based on monitored user environmental factors 212 as previously explained, followed by the selection of an initial authentication method in step 216 that is considered appropriate for the calculated risk profile. In other words, the initial authentication method applied in step 202 may or may not consider the initial risk profile of the user.

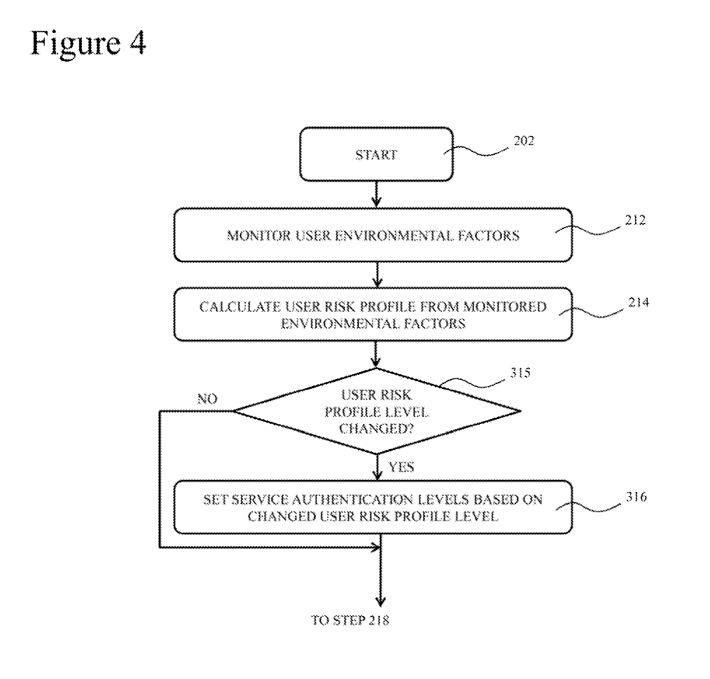

Another alternative embodiment of the method of the claimed subject matter is shown in FIG. 4, which provides a variation to an aspect of the method shown in FIG. 2A. In FIG. 4, steps 202, 212 and 214 may be the same as in FIG. 2. In step 315 it is not only checked if the risk profile of the user has changed, but it is additionally checked if this change has led to a change in the risk profile level. In other words, in this embodiment, risk profile scores may be categorized in risk bands, e.g.:

| | |
|---|---|
| 0-25 | low risk |
| 26-65 | medium risk |
| 66-100 | high risk |

It will be understood that the number of bands and the boundaries of the bands are chosen by way of non-limiting example, and that any suitable number of bands with any suitable band boundaries may be chosen.

Next, the method proceeds to step 316 only if a change in the risk profile of the user has led to a transition from one risk level to a second risk level, e.g. from low to medium risk, in which case the service authentication levels for the services provided by the computer system are set in accordance with the actual risk level. This may for instance be achieved by the generation of a notification signal to notify a module responsible for implementing step 316 of the change in risk level. Otherwise, step 316 is skipped and the method proceeds directly to step 218 as shown in FIG. 2, after which the method proceeds as previously discussed with the aid of FIGS. 2 and 3.

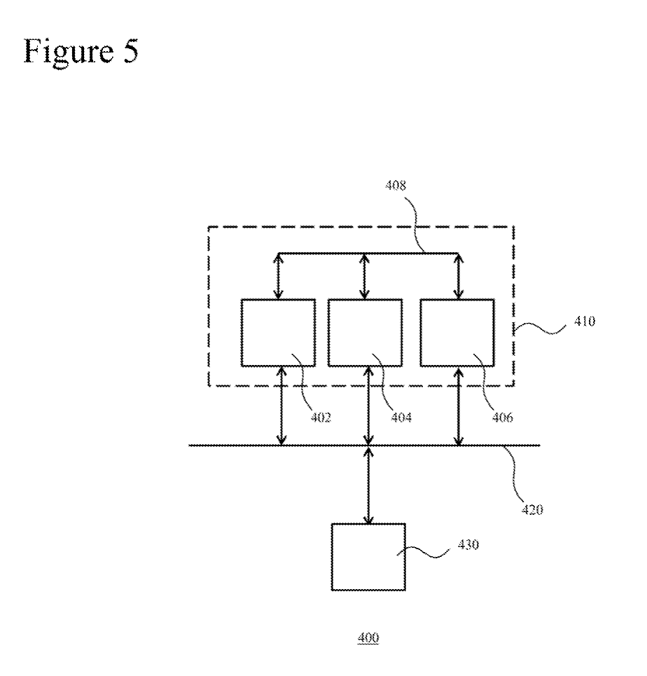

FIG. 5 schematically depicts a computer system 400 according to an embodiment of the claimed subject matter. The computer system 400 comprises a risk profile monitor 402 adapted to dynamically monitor a risk profile of a user authenticated on said computer system and an authentication module 404 adapted to dynamically select an authentication level for a service based on the monitored risk profile. The authentication module 404 may be further adapted to compare the dynamically selected authentication level with the actual authentication level of said user upon said user requesting access to said service and to send a further authentication request to the user requesting the user to provide authentication information corresponding to the dynamically selected authentication level if the dynamically selected authentication level is higher than the actual authentication level for said user as previously explained.

The computer system 400 further comprises an environmental monitor 406 adapted to monitor user-relevant data, i.e. environmental factors, selected from at least one of biometric data, location data, environmental data and user device monitoring data. The environmental monitor 406 is typically communicatively connected to the risk monitor 402 to allow the risk monitor 402 to dynamically determine the risk profile of the user based said user-relevant data, with the risk monitor 402 being communicatively connected to the authentication module 404 to allow the authentication module 404 to dynamically select an authentication level for a service based on the risk profile monitored by the risk monitor 402, e.g. by providing the authentication module 404 with a notification signal signaling a change in the risk level of the user as explained in more detail with the aid of FIG. 4.

The risk monitor 402, authentication module 404 and environmental monitor 406 may be communicatively coupled via a network 420, e.g. a wired or wireless Ethernet or Internet connection, a 2 G, 3 G, 4 G connection and so on, and/or via a dedicated connection 408 such as a bus internal to the computer system 400.

In an embodiment, the computer system may further comprise a user terminal 430, such as one or more ATMs, which may be communicatively connected to at least the authentication module 404 and the environmental monitor 406 via the network 420.

The various steps of embodiments of the method of the claimed subject matter may be defined in terms of computer program code, which code may be stored on a computer-readable medium, such that the method of the claimed subject matter may be implemented by one or more processors of the computer system by retrieving the computer program code from the computer-readable medium and executing the computer program code. In this embodiment, the modules 402, 404 and 406 may be realized by computer program code executed on a processor architecture 410, which processor architecture may comprise one or more processors and data storage such as a memory, hard disk, NAS, SAN, network server and so on comprising the computer program code.

Alternatively, the computer system may have one or more dedicated hardware modules 402, 404 and 406 for executing at least some steps of the method of the claimed subject matter. In other words, the method of the claimed subject matter may be present on the computer system entirely as software, in the form of a software/hardware co-design or entirely in hardware.

While particular embodiments of the claimed subject matter have been described herein for purposes of illustration, many modifications and changes will become apparent to those skilled in the art. Accordingly, the appended claims are intended to encompass all such modifications and changes as fall within the true spirit and scope of this invention.

We claim:

1. A method for providing a user access to a computer system comprising a plurality of services and a plurality of authentication levels, the method comprising:
dynamically monitoring a risk profile of a user authenticated on said computer system;
dynamically selecting an authentication level for each of said services based on said monitored risk profile; and
determining said authentication level for a service is higher than an actual authentication level for said user; and
in response to the determining, sending a further authentication request to the user requesting the user to provide authentication information corresponding to at least the dynamically selected authentication level upon said authenticated user requesting access to said service.

2. The method of claim 1, further comprising, on said computer system:
receiving the further authentication information from said user;
verifying the further authentication information; and
providing the user access to the requested service upon positive verification of the further authentication information.

3. The method of claim 1, further comprising:
receiving a request on said computer system from a user to access a service on said computer system;
determining an initial risk profile of said user;
selecting an initial authentication level based on said initial risk profile; and
sending an initial authentication request to the user requesting the user to provide authentication information corresponding to the dynamically selected initial authentication level.

4. The method of claim 3, further comprising, on said computer system:
receiving the initial authentication information from said user;
verifying the initial authentication information; and
providing the user access to the computer system upon positive verification of the initial authentication information.

5. The method of claim 1, wherein the dynamically monitoring of a risk profile of a user comprises collecting user-relevant data selected from at least one of biometric data, location data, environmental data and user device monitoring data.

6. The method of claim 1, wherein the risk profile comprises a plurality of risk levels, the method further comprising generating a notification signal upon a transition of the monitored risk profile from a first risk level to a second risk level.

7. The method of claim 1, further comprising adjusting the risk profile of the user upon said user providing incorrect authentication information.

8. A apparatus for providing a user access to a computer system comprising a plurality of services and a plurality of authentication levels, the apparatus comprising:
a plurality of processors;
a non-transitory computer readable storage medium coupled to the plurality of processors; and
logic, stored on the computer-readable storage medium and executed on the plurality of processors, for:
dynamically monitoring a risk profile of a user authenticated on said computer system;
dynamically selecting an authentication level for each of said services based on said monitored risk profile;
determining that said authentication level for a service is higher than an actual authentication level for said user; and
in response to the determining, sending a further authentication request to the user requesting the user to provide authentication information corresponding to at least the dynamically selected authentication level upon said authenticated user requesting access to said service.

9. The apparatus of claim 8, the logic further comprising logic for:
receiving the further authentication information from said user;
verifying the further authentication information; and
providing the user access to the requested service upon positive verification of the further authentication information.

10. The apparatus of claim 8, the logic further comprising logic for:
receiving a request on said computer system from a user to access a service on said computer system;
determining an initial risk profile of said user;
selecting an initial authentication level based on said initial risk profile; and
sending an initial authentication request to the user requesting the user to provide authentication information corresponding to the dynamically selected initial authentication level.

11. The apparatus of claim 10, the logic further comprising logic for:
receiving the initial authentication information from said user;
verifying the initial authentication information; and
providing the user access to the computer system upon positive verification of the initial authentication information.

12. The apparatus of claim 8, wherein the logic for dynamically monitoring of a risk profile of a user comprises logic for collecting user-relevant data selected from at least one of biometric data, location data, environmental data and user device monitoring data.

13. The apparatus of claim 8, wherein the risk profile comprises a plurality of risk levels, the logic further comprising logic for generating a notification signal upon a transition of the monitored risk profile from a first risk level to a second risk level.

14. The apparatus of claim 8, the logic further comprising logic for adjusting the risk profile of the user upon said user providing incorrect authentication information.

15. A computer programming product for providing a user access to a computer system comprising a plurality of services and a plurality of authentication levels, the apparatus comprising:
a non-transitory computer readable storage medium; and
logic, stored on the computer-readable storage medium for execution on a plurality of processors, for:
dynamically monitoring a risk profile of a user authenticated on said computer system;
dynamically selecting an authentication level for each of said services based on said monitored risk profile;
determining that said authentication level for a service is higher than an actual authentication level for said user; and
in response to the determining, sending a further authentication request to the user requesting the user to provide authentication information corresponding to at least the dynamically selected authentication level upon said authenticated user requesting access to said service.

16. The computer programming product of claim 15, the logic further comprising logic for:
receiving the further authentication information from said user;
verifying the further authentication information; and
providing the user access to the requested service upon positive verification of the further authentication information.

17. The computer programming product of claim 15, the logic further comprising logic for:
receiving a request on said computer system from a user to access a service on said computer system;
determining an initial risk profile of said user;
selecting an initial authentication level based on said initial risk profile; and
sending an initial authentication request to the user requesting the user to provide authentication information corresponding to the dynamically selected initial authentication level.

18. The computer programming product of claim 15, wherein the logic for dynamically monitoring of a risk profile of a user comprises logic for collecting user-relevant data selected from at least one of biometric data, location data, environmental data and user device monitoring data.

19. The computer programming product of claim 15, wherein the risk profile comprises a plurality of risk levels, the logic further comprising logic for generating a notification signal upon a transition of the monitored risk profile from a first risk level to a second risk level.

20. The computer programming product of claim 15, the logic further comprising logic for adjusting the risk profile of the user upon said user providing incorrect authentication information.
